(19) United States
(12) Patent Application Publication
(10) Pub. No.: US 2005/0080672 A1
(43) Pub. Date: Apr. 14, 2005

(54) Creating customer loyalty

(75) Inventors: Colette Courtion, Seattle, WA (US); Mary Stumpf, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Starbucks Corporation

(21) Appl. No.: 10/943,110

(22) Filed: Sep. 16, 2004

Related U.S. Application Data
(63) Continuation of application No. PCT/IB03/04495, filed on Oct. 13, 2003.
(60) Provisional application No. 60/511,054, filed on Oct. 14, 2003.

(51) Int. Cl. G06F 17/60

(52) U.S. Cl. 705/14

(57) ABSTRACT

A system for rewarding the loyalty of a payment cardholder comprises a dual card for facilitating credit transactions associated with a credit account and further facilitating stored value transactions associated with a stored value account. The system further comprises a computer-implemented loyalty program for calculating a loyalty value based on the credit transactions of the dual card, the loyalty value being used to load the stored value account of the dual card. The system yet further comprises a rebate file produced by a credit card issuing bank. The rebate file contains a rebate based on the credit transactions.

### CROSS-REFERENCES TO RELATED APPLICATIONS

This application is a continuation of PCT/IB03/04495, designating the United States, filed Oct. 13, 2003. This application further claims the benefit of U.S. Provisional Application No. 60/511,054, filed Oct. 14, 2003.

### FIELD OF THE INVENTION

The present invention relates generally to promotional programs, and more particularly, to developing loyalty among customers who use payment cards.

### BACKGROUND OF THE INVENTION

To be successful, all businesses promote their products or services in one way or another. Whether a business is selling durable goods (used repeatedly over time, such as refrigerators) or non-durable goods (consumed within a short time, such as coffee), it has to find a suitable business method to further the acceptance and sale of merchandise or services by consumers through promotional programs. Three promotional programs are typically used: personal selling, advertising, and sales promotion.

Personal selling is perhaps the oldest. Appearing late in the 19^{th} century, in this promotional program, a traveling representative of a business concern solicits orders, usually in an assigned territory. Early intrepid hucksters carried their goods on their back or on their donkey, working their way from a harbor town through the backcountry limiting their sales to stock on hand for transactions with would-be consumers. Persuasive sales skill was less important in those days of hungry demand, and orders were readily forthcoming. Over time, however, with the increasing supply of manufactured goods, consumers became more discriminating in their purchases. As the cost of personal selling has increased dramatically (due to salary, automobile upkeep, benefits, and so on), most businesses today rely on advertising to pre-sell their products so as to convince consumers to buy before the consumers actually can see and inspect the products. The use of salespeople has diminished or changed.

A consumer who has experienced a deluge of credit card offers in the mail is familiar with sales promotion. The purpose of sales promotion is to round out advertising and personal selling. Sales promotion may involve special incentives to induce consumers to close the sale of goods or services. During a lull in economic activities, when demand for consumers' precious dollars becomes especially competitive, there is a greater participation in sales promotion by all businesses.

As indicated above, credit card offers are an example of sales promotion. Consumers today have their pick of credit card issuers to patronize. Consumers are inundated with campaigns to switch credit cards with no or low interest rates. Fail to retain consumers' interest, and it takes only a signature for them to switch to a competitor's credit card program. Successful credit card issuers woo consumers to linger long enough in their credit card programs to turn a profit by providing promotional programs, such as a credit card promotional program 108.

A credit card 102 is a payment card that is a flat, stiff, usually small, and rectangular piece of plastic material bearing financial information that extends credit privileges to cardholders so that account balances need not be paid in full each month, but in increments over time with interest. To purchase goods or services, such as a purchased product 106A (e.g., a sweater), a cardholder presents the credit card 102 to a clerk who swipes the credit card 102 through a card reader 104. See FIG. 1. The financial information obtained from the swiping process causes a charge to appear on a credit account to pay for the purchased product 106A. To retain the interest of the cardholder of the credit card 102, a credit card issuer maintains the credit card promotional program 108 to help induce the cardholder to maintain and use the credit account.

One typical credit card promotional program 108 is an air mile program 110. For each dollar that is charged by the cardholder to the credit card 102, the cardholder earns one air mile that can be eventually used to redeem an airline ticket for travel. One problem with the air mile program 110 is that it requires the cardholder of the credit card 102 to spend a substantial sum of money to be qualified for an airline ticket. For example, to earn one round trip ticket to an international destination may require 50,000 miles to be earned. This translates into $50,000 that must be charged on the credit card 102 by the cardholder. Typically, it takes an average consumer three to five years to earn one airline ticket. Moreover, many air mile programs require the cardholder of the credit card 102 to manually tally up earned air miles; call a telephone number to request a redeemable coupon; wait in hope that the coupon will be mailed; and attempt to schedule a trip without running into a multitude of restrictions, such as blackout dates, and so on.

Another promotional program is a cash back program 112, which is used by a few credit card issuers. The cash back program 112 provides a percentage of charges made on the credit card 102 as refund money back to the cardholder of the credit card 102. However, the cash back program 112 typically requires that the cardholder of the credit card 102 spend for at least a year before any money will be returned to the cardholder of the credit card 102. In other words, the cardholder of the credit card 102 must wait for one year until he sees the cash back promised by the issuer of the credit card 102.

The credit card promotional program 108 makes sense for credit card businesses whose model is based on use of the credit privileges of the credit card 102 over an extended period of time. The more the cardholder of the credit card 102 charges to the credit card 102, the greater the likelihood of a balance being carried from month to month. Because interest is imposed on the carried balance, the credit card issuer is sure to obtain a stream of revenue from the interest incurred by the cardholder of the credit card 102.

While the above model may be appropriate for credit card businesses, it may not be appropriate for businesses whose revenue is not dependent on a carried balance but instead on the loyalty of the consumer to purchase with certain regularity goods that are non-durable, such as coffee. Without a more rewarding promotional program to retain the goodwill of consumers, consumers' demand for the goods or services of such a business will diminish in the marketplace over time. Thus, there is a need for a system and method for rewarding customer loyalty while avoiding or reducing the foregoing and other problems associated with existing promotional programs.

### SUMMARY OF THE INVENTION

In accordance with this invention, a system, method, and computer-readable medium for making payment transactions is provided. The system form of the invention includes a system for rewarding the loyalty of a payment cardholder. The system comprises a dual card for facilitating credit transactions associated with a credit account and further facilitating stored value transactions associated with a stored value account. The system further comprises a computer-implemented loyalty program for calculating a loyalty value based on the credit transactions of the dual card, the loyalty value being used to load the stored value account of the dual card. The system yet further comprises a rebate file produced by a credit card issuing bank. The rebate file contains a rebate based on the credit transactions. The rebate file is used to aid the calculation of the loyalty value. The system as yet further comprises a stored value transaction file produced by a stored value processor. The stored value transaction file is used to aid the calculation of the loyalty value. The system also comprises an amount of money donated to a philanthropic organization based on the loyalty value. The system yet also comprises merchandise sent to the cardholder of the dual card based on the loyalty value.

A method form of the invention includes a method for rewarding a cardholder of a dual card. The method comprises calculating a loyalty value from credit transactions of the dual card, calculating the loyalty value from stored value transactions of the dual card, and loading a stored value account of the dual card by the calculated loyalty value. The method further comprises forming a first transaction premium file if the credit transactions include a first credit transaction. The method yet further comprises accruing a rebate amount for each credit transaction. The method as yet further comprises accruing a rebate amount for each credit transaction that automatically occurs when a stored value account of the dual card is below a threshold. The method also includes donating to a philanthropic organization by a sponsor business, which sponsors the dual card. The method yet also includes sending a piece of merchandise to the cardholder of the dual card.

A computer-readable form of the invention includes a computer-readable medium having instructions stored thereon for performing a method for rewarding a cardholder of a dual card. The method comprises calculating a loyalty value from credit transactions of the dual card, calculating the loyalty value from stored value transactions of the dual card, and loading a stored value account of the dual card by the calculated loyalty value. The method further comprises forming a first transaction premium file if the credit transactions include a first credit transaction. The method yet further comprises accruing a rebate amount for each credit transaction. The method as yet further comprises accruing a rebate amount for each credit transaction that automatically occurs when a stored value account of the dual card is below a threshold. The method also includes donating to a philanthropic organization by a sponsor business, which sponsors the dual card. The method yet also includes sending a piece of merchandise to the cardholder of the dual card.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating a conventional system showing various problems of credit card promotional programs in retaining consumer interest;

FIG. 2A is a block diagram illustrating an exemplary system for processing a dual card that operates on both an open network and a closed network;

FIG. 2B is a block diagram illustrating a loyalty program for a dual card that operates on both an open network and a closed network, according to one embodiment of the present invention;

FIG. 2C is a block diagram illustrating pieces of a system for implementing a loyalty program for a dual card, according to one embodiment of the present invention; and

FIGS. 3A-3J are process diagrams illustrating a method for rewarding a loyal customer who uses a dual card, according to one embodiment of the present invention.

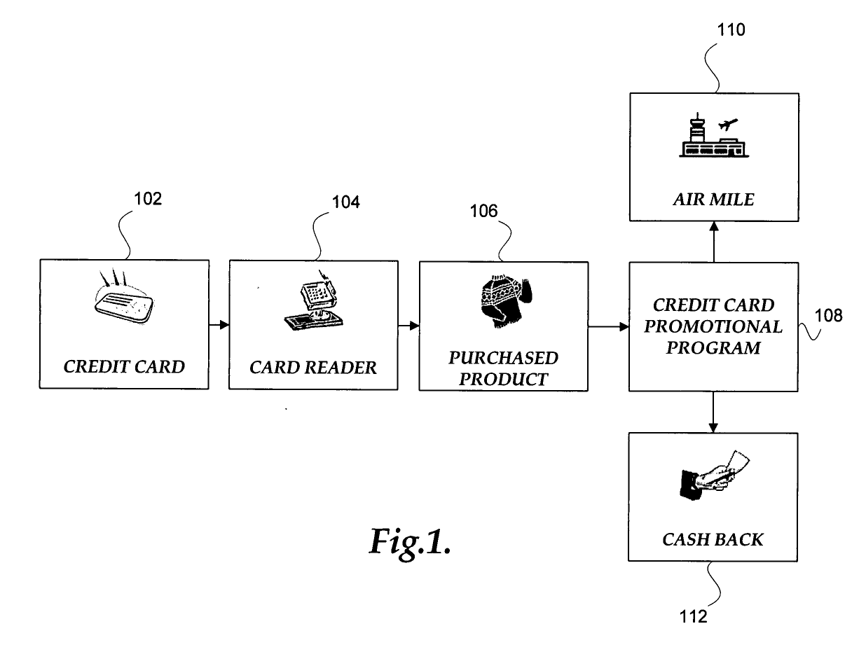

### DETAILED DESCRIPTION OF THE PREFERRED EMBODIMENT

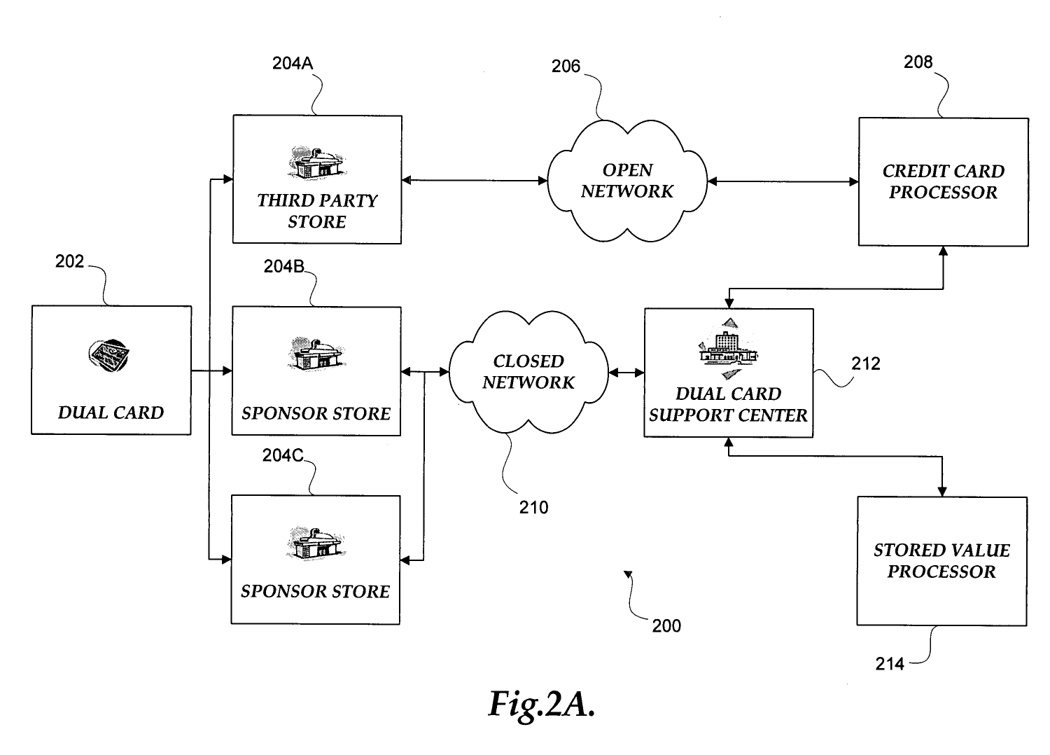

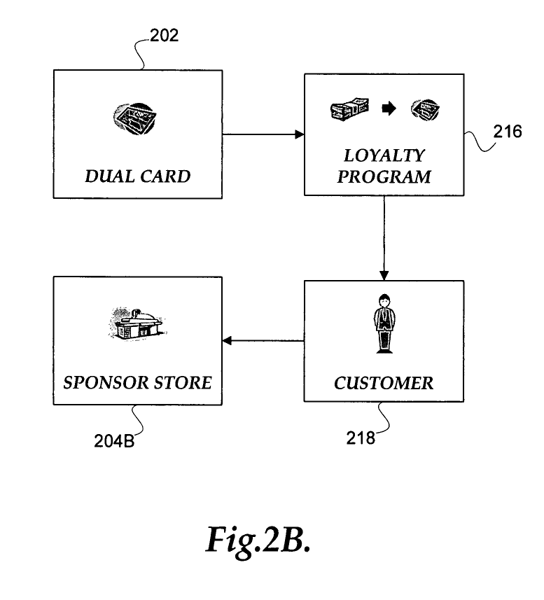

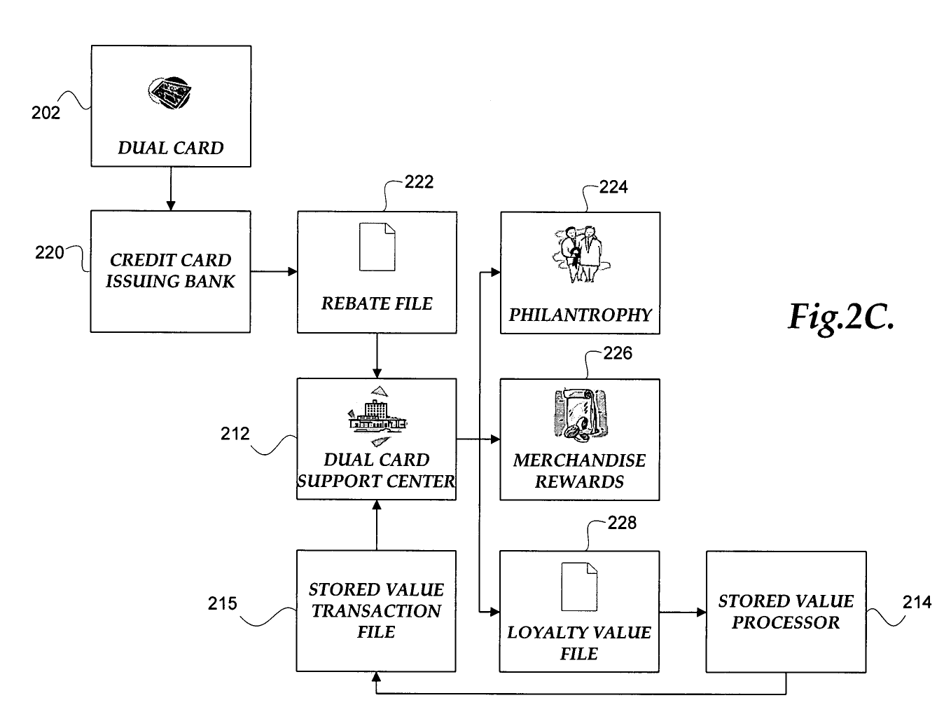

A dual card 202, which facilitates payment for goods or services from either a credit account or a stored value account, operates within a system 200 illustrated at FIG. 2A. The dual card 202 is a payment card that integrates the ability to provide credit privileges and stored value privileges to a cardholder of the dual card 202. The features, benefits, and advantages of a stored value card are integrated with the credit card aspects of the dual card 202. The benefits, features, and advantages of a credit card are integrated with a stored value card. The dual card 202 is sponsored by a sponsor business, which can emboss the dual card 202 with its brand name and earn favor and prestige from the cardholder beyond the mere value of what the sponsor business sells. The dual card 202, unlike a credit card or a stored value card, can be used on both an open network 206 and a closed network 210 in a system 200. When used on the open network 206, the dual card 202 can be accepted anywhere in the world where a credit card is accepted as payment for goods or services.

When the dual card 202 is used in the third-party store 204A, credit privileges are extended to the cardholder of the dual card 202. Credit payment transactions are communicated from the third-party store 204A to a credit card processor via the open network 206, which is a system of computers, terminals, and databases connected by communication lines to reliably exchange credit payment information. The third-party store 204A is a retail business establishment that sells goods or provides services directly to consumers. The third-party store 204A is neither associated with the sponsor business nor licensed by the sponsor business to use the dual card 202.

The sponsor business has a number of sponsor stores 204B-204C, which are business establishments where goods of a particular theme are kept for retail sale or services of a similar theme are provided to consumers. When the dual card 202 is used at sponsor stores 204B-204C, both credit privileges and stored value privileges are extended to the cardholder of the dual card 202. In other words, the cardholder of the dual 202 can use the dual card 202 as a credit card or as a stored value card in the sponsor stores 204B-204C. Sponsor stores 204B-204C not only include business establishments of the sponsor business in which the dual card 202 is accepted, but also other business establishments that are licensed to sell goods or provide services created by the sponsor business.

Payment transactions generated from the use of the dual card 202 in the sponsor stores 204B-204C are communicated to a dual card support center 212 via the closed network 210. The closed network 210 consists of many small and large computers distributed over a vast geographic area (WAN or wide area network). One exemplary implementation of a WAN is the Internet, which is a worldwide collection of networks and gateways that use the TCP/IP suite of protocols to communicate with one another. At the heart of the Internet is a backbone of high-speed data communication lines between major nodes or host computers, including thousands of commercial, government, educational, and other computer systems that route data and messages.

The dual card support center 212 is preferably maintained by the sponsor business to house a number of computers to provide support services, such as access to account files associated with cardholders of dual cards or routing of payment transactions to the credit card processor 208 or to a stored value processor 214. Whereas the credit card processor 208 processes credit payment transactions connected with the credit account of the dual card 202, the stored value processor 214 processes stored value payment transactions connected with the stored value account of the dual card 202.

Point-of-sale machines, located at sponsor stores 204B-204C, can detect whether a credit payment transaction or a stored value payment transaction is desired by a customer. If a payment transaction is a credit payment transaction, the credit payment transaction will be transmitted from a point-of-sale machine located in one of the sponsor stores 204B-204C to the dual card support center 212 via the closed network 210. The dual card support center 212 communicates with the credit card processor 208 to obtain authorization for the credit payment transaction. Approval or rejection of the credit payment transaction is communicated from the credit card processor 208 to the dual card support center 212. The dual card support center 212 communicates the approval or rejection of the credit payment transaction to the point-of-sale machine at the sponsor stores 204B-204C from which the credit payment transaction originated. Settlement of credit payment transactions is preferably done at the end of a business day to credit or debit/credit accounts of cardholders of dual cards and the sponsor business.

If a payment transaction is a stored value payment transaction, the stored value payment transaction is transmitted from a point-of-sale machine located in one of the sponsor stores 204B-204C to the dual card support center 212 via the closed network 210. The dual card support center 212 communicates with the stored value processor 214 to obtain authorization for the stored value payment transaction. Approval or rejection of the stored value payment transaction is communicated from the stored value processor 214 to the dual card support center 212. The dual card support center 212 communicates the approval or rejection of the stored value payment transaction to the point-of-sale machine at the sponsor stores 204B-204C from which the stored value payment transaction originated.

A customer 218 who is a cardholder of the dual card 202 is preferably qualified for a loyalty program 216 maintained by the sponsor business. The loyalty program 216 provides a bounty, reward, premium, subsidy, or grant to customer 218 chiefly as an inducement or an incentive for the customer 218 to remain faithful to the sponsor business in the use of the dual card 202. The bounty, reward, premium, subsidy, or grant is triggered by the usage of the credit card privileges of the dual card 202, the stored value privileges of the dual card 202, or a combination of both the credit privileges and the stored value privileges. No black out dates or a year-long wait is needed for various bounties, rewards, premiums, subsidies, or grants to be earned by the customer 218.

The usage of credit privileges, stored value privileges, or a combination thereof over a defined period of time can be calculated to form a loyalty value. This loyalty value can be translated into a bounty, reward, premium, subsidy, or grant by the loyalty program 216. Preferably, the bounty, reward, premium, subsidy, or grant is in the form of stored value that can be loaded onto the stored value account of the dual card 202 so as to allow the customer 218 to easily redeem such a value at a sponsor's store 204B. However, other suitable bounty, reward, premium, subsidy, or grant is possible, such as a donation by the sponsor business on the customer's behalf to a philanthropic organization, or merchandise gifts sent from the sponsor business to the customer 218.

The loyalty program 216 of various embodiments of the present invention can be understood as a feedback loop to reward the customer 218 for his continued usage of the dual card 202. The loyalty program 216 creates a commercial coupling between the credit privileges of the dual card 202 and the stored value privileges of the dual card 202. The bounty, reward, premium, subsidy, or grant generated by the customer 218's usage of the credit privileges of the dual card 202 is returned to the customer 218 by loading the stored value account associated with the stored value privileges of the dual card 202 with a monetary value. This relationship strengthens the loyalty the customer 218 feels with regard to the credit privileges of the dual card 202 as well as to the stored value privileges of the dual card 202. The customer 218 redeems the bounty, reward, premium, subsidy, or grant by visiting the sponsor store 204b, hence strengthening the commercial relationship between the sponsor business and the customer 218. Because the dual card 202 is sponsored by the sponsor business, which can emboss the dual card 202 with its brand name, the loyalty program 216 helps to earn favor and prestige for the sponsor business from the customer 218 beyond the mere value of what the sponsor business sells or provides.

For businesses that supply non-durable goods, such as coffee, it is preferable that the loyalty program 216 provide feedback to the customer 218 with more frequency than to customers who consume durable goods. For example, a business that relies on selling coffee to the customer 218 at the sponsor store 214B relies on the loyalty of the customer 218 to purchase coffee with frequency from the sponsor store 204B to create a stream of revenue to maintain the sponsor business as a going concern. The loyalty program 216 suitably provides a bounty, reward, premium, subsidy, or grant to entice the customer 218 to visit the sponsor store 204B more often than other businesses that sell non-durable goods.

FIG. 2C illustrates pieces of a system for implementing the loyalty program 216 for the sponsor business. As the credit privileges of the dual card 202 are used by the customer 218, credit transactions are accrued by the credit card issuing bank 220. Preferably, the credit card issuing bank 220 accrues credit transactions and a rebate associated with credit transactions with certain regularity, such as at the end of a billing cycle for the use of credit privileges by the customer 218 who is the cardholder of the dual card 202.

The transactions accrued by the credit card issuing bank 220 include the first transaction of the dual card 202 by the customer 218. Various bounties, rewards, premiums, subsidies, or grants associated with the first transaction of the dual card 202 include a donation, which comprises a flat dollar amount, to a pre-assigned philanthropic organization by the sponsor business. Various other bounties, rewards, premiums, subsidies, or grants include a monetary load, which is a flat dollar amount added to a stored value account of the dual card 202. Various other transactions accrued by the credit card issuing bank 220 include whether the dual card 202 is a first edition dual card. Cardholders who signed up within a predetermined period for the dual card are preferably rewarded by a bounty, reward, premium, subsidy, or grant that suitably varies from year to year. One suitable initial reward is merchandise. Subsequent rewards may suitably include monetary loads onto the stored value account associated with the dual card 202. Further transactions accrued by the credit card issuing bank 220 include a rebate of a predetermined percentage point based on all credit card transactions associated with the credit privileges of the dual card 202. Another rebate is an auto-reload rebate, which preferably has a different percentage point rebate. The auto-reload rebate occurs when the customer 218 has registered the dual card 202 with the sponsor business to use the credit account associated with the dual card 202 to automatically reload the stored value account when the stored value account has diminished to a point below a certain threshold.

At a suitable time period, such as at the end of the billing cycle, the credit card issuing bank 220 issues a rebate file 222, whose information can be used to calculate bounties, rewards, premiums, subsidies, or grants earned by the use of credit privileges of the dual card 202 by the customer 218. The rebate file 222 is sent to the dual card support center 212 for calculating a loyalty value associated with credit transactions on the dual card 202.

Depending on the level of the calculated loyalty value, the sponsor business contributes an amount of money to a philanthropic organization 224 on behalf of the customer 218 who is the cardholder of the dual card 202. Merchandise rewards 226 are sent to the customer 218 depending on the level of the loyalty value calculated by the dual card support center 212 based on the rebate file 222. Various levels of merchandise rewards are possible. At one level, merchandise such as mugs, bags of coffee, and so on are sent to the customer 218. At another level, higher-value merchandise is sent to the customer 218 instead. In other instances, the calculated loyalty value by the dual card support center 212 is placed in a loyalty value file 228. The stored value processor 214 retrieves the loyalty value file 228 and loads the stored value account associated with the dual card 202 by an amount indicated by the loyalty value file 228.

Loyalty value can be calculated from credit transactions associated with the credit card account of the dual card 202. However, loyalty value can also be calculated from stored value transactions as well. When the customer 218 uses stored value privileges of the dual card 202, stored value transactions are generated and stored by the stored value processor 214. The stored value processor 214 preferably reports those transactions by forming a stored value transaction file 215. The dual card support center 212 retrieves the stored value transaction file 215 to calculate loyalty value associated with stored value transactions. Depending on the level of the loyalty value associated with stored value transactions, the sponsor business can donate to the philanthropic organization 224, send merchandise rewards 226 to the customer 218, or load the stored value account associated with the dual card by a calculated loyalty value amount based on stored value transactions.

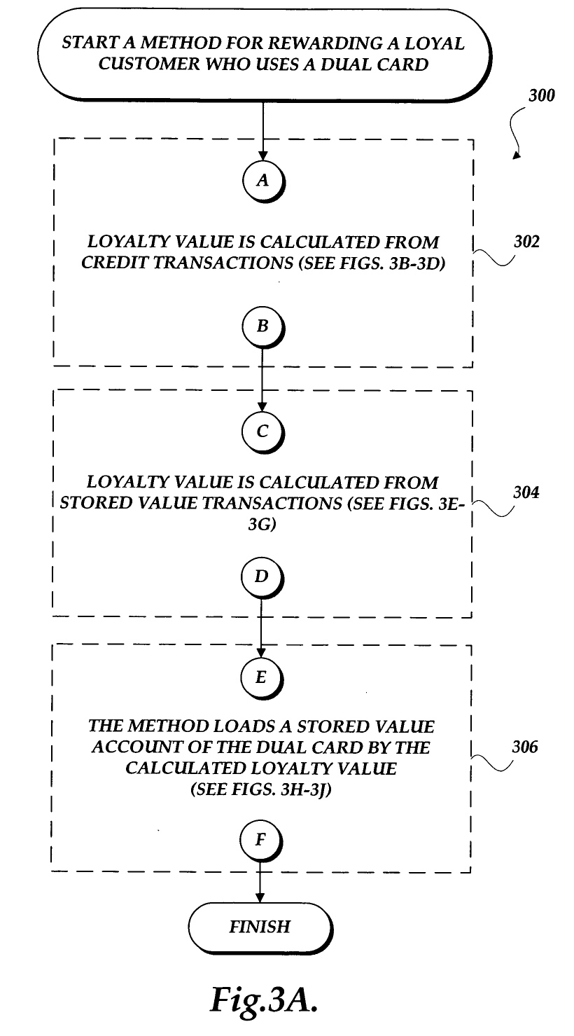

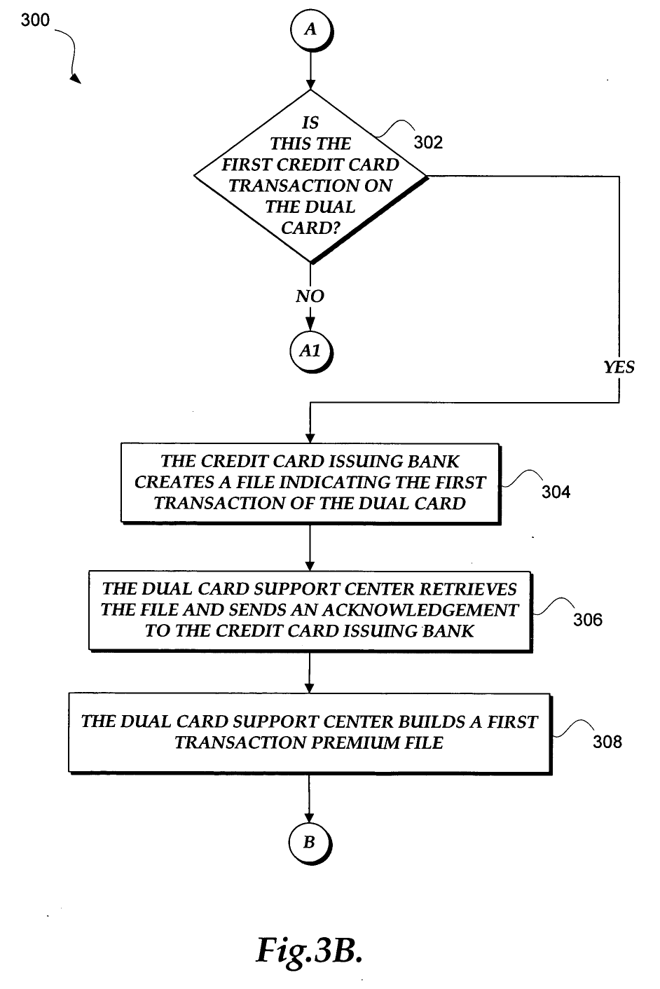

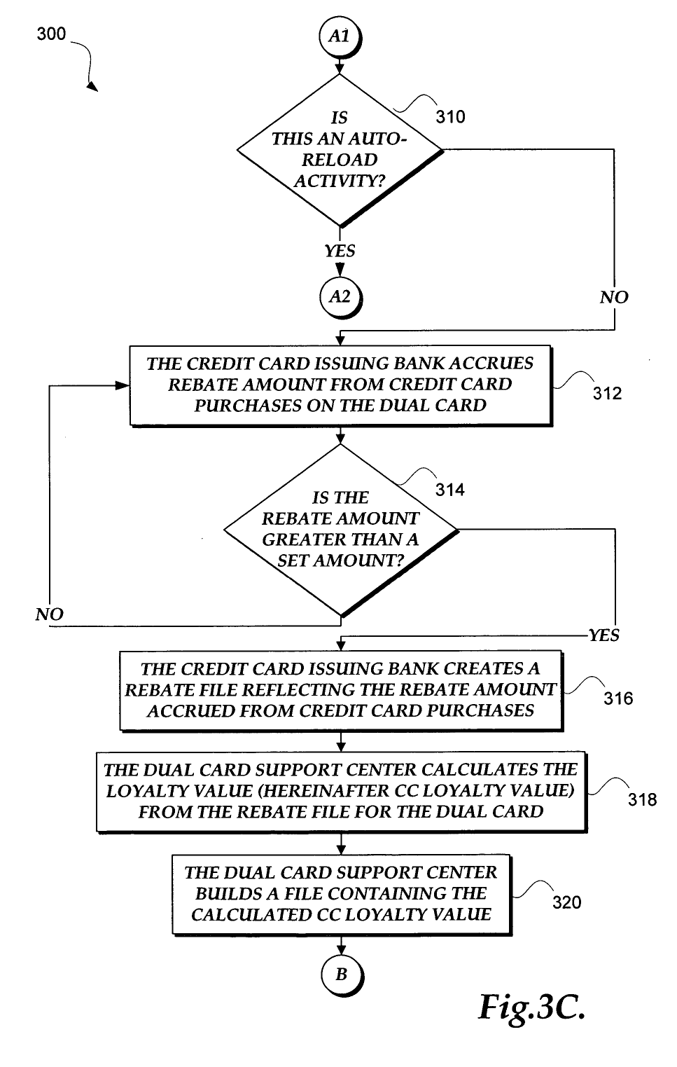

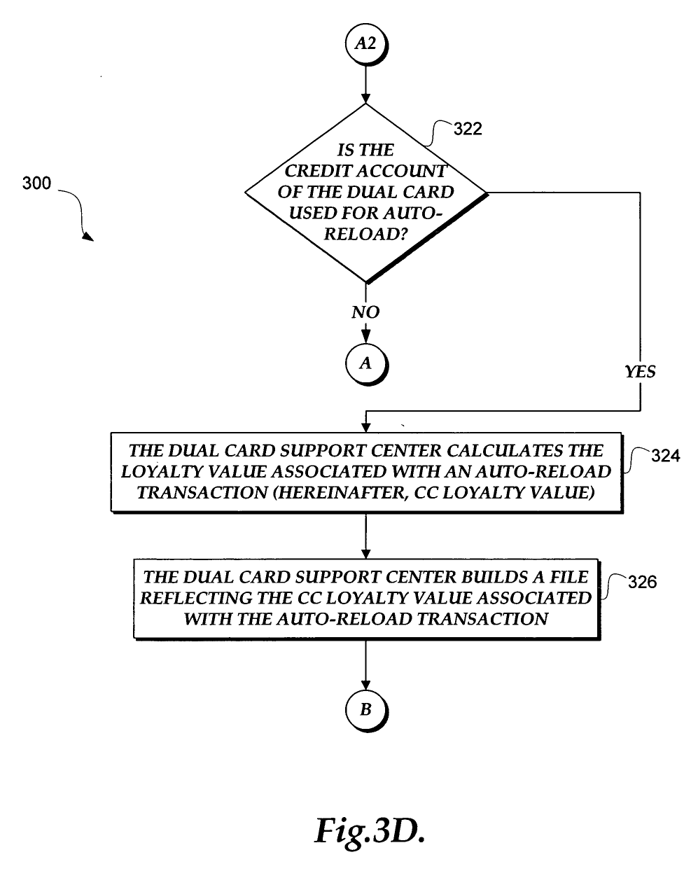

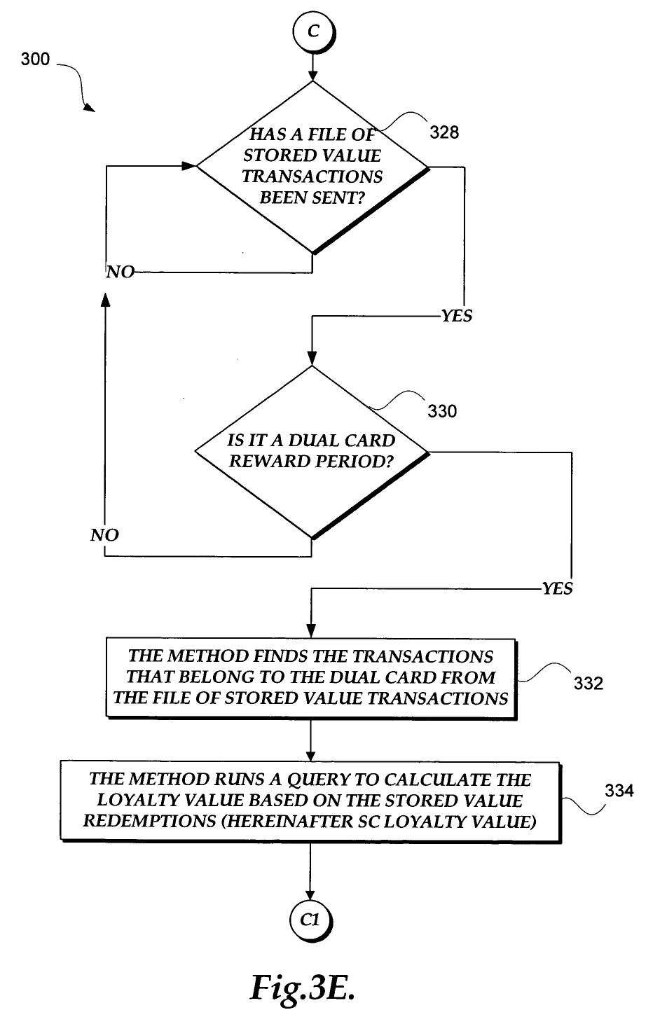

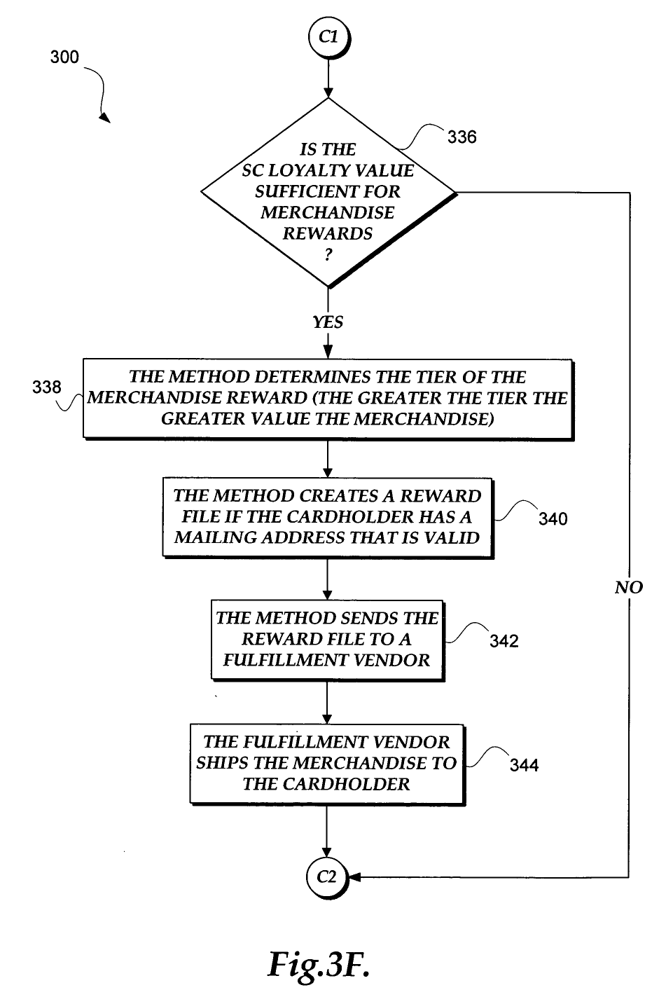

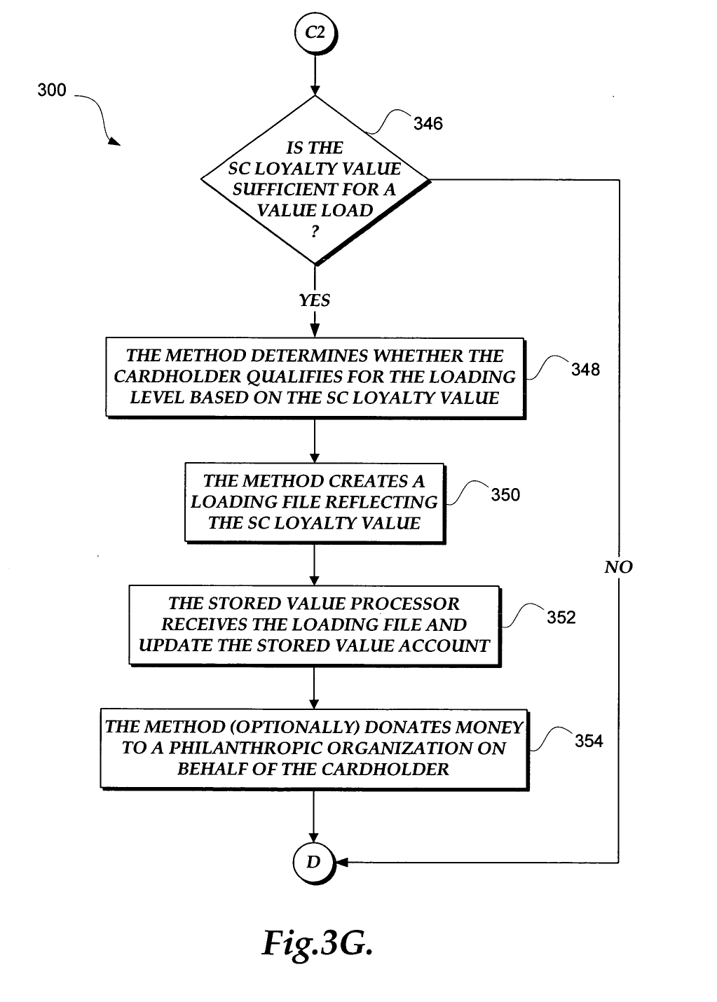

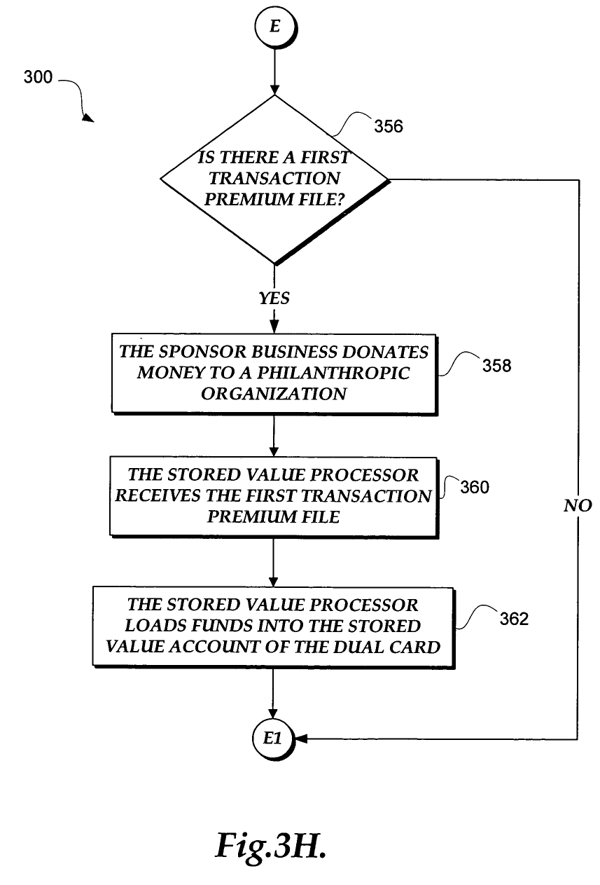

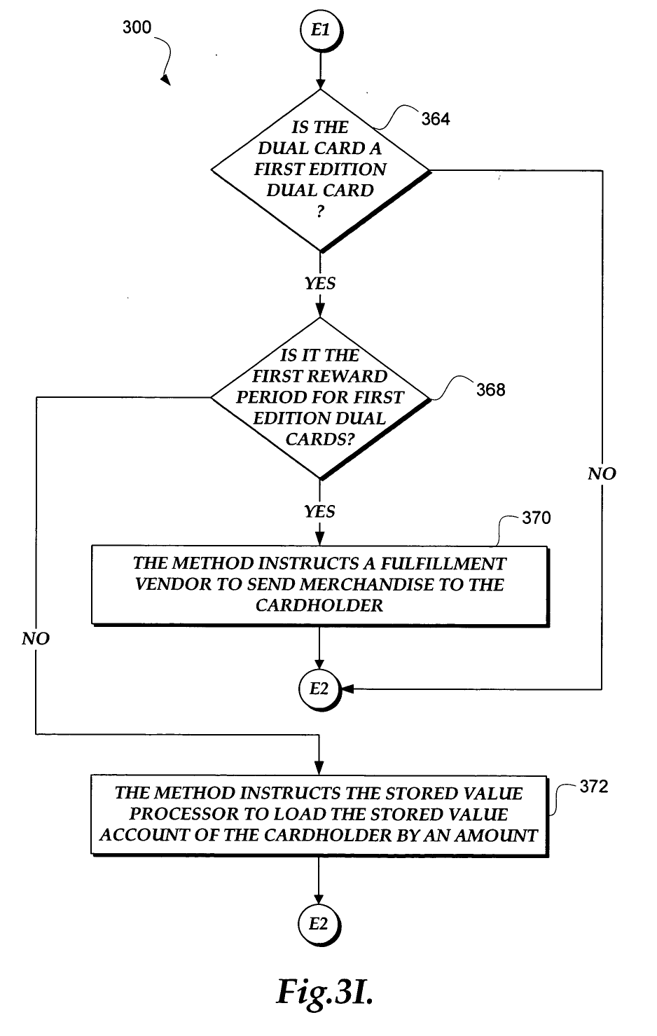

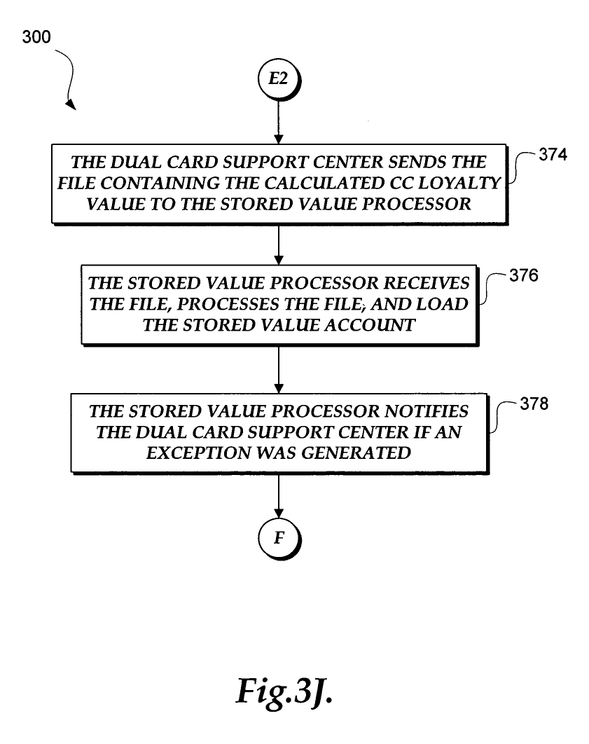

FIGS. 3A-3J illustrate a method 300 for rewarding a loyal customer who uses a dual card 202. For clarity purposes, the following description of the method 300 makes reference to various elements illustrated in connection with a system 200 (FIG. 2A), the dual card 202, the stored value processor 214, the credit card issuing bank 220 (FIG. 2C), the dual card support center 212, the philanthropic organization 224, merchandise rewards 226, and the loyalty value file 228.

From a start block, the method 300 proceeds to a set of method steps 302, defined between a continuation terminal (“terminal A”) and an exit terminal (“terminal B”). The set of method steps 302 describes the calculation of loyalty value from credit card transactions (e.g., the first credit card transaction, subsequent credit card transactions, and auto-reload activities associated with the dual card 202).

From terminal A (FIG. 3B), the method 300 proceeds to decision block 302 where a test is made to determine whether a credit card transaction recorded by the credit card issuing bank 220 is the first credit transaction on the dual card 202. If the answer is NO, the method 300 proceeds to another continuation terminal (“terminal A1”). If the answer to the test at decision block 302 is YES, the method 300 proceeds to block 304 where the credit card issuing bank 220 creates a file indicating the first transaction of the dual card 202. The dual card support center 212 retrieves the file and sends an acknowledgment to the credit card issuing bank 220. See block 306. At block 308, the dual card support center 212 builds a first transaction premium file (which will be processed later to provide a bounty, reward, premium, subsidy, or grant to the customer 218). The method 300 then proceeds to the exit terminal B.

From terminal A1 (FIG. 3C), the method 400 proceeds to decision block 310 where a test is made to determine whether the credit transaction is an auto-reload activity. If the answer to the test at decision block 310 is YES, the method 300 proceeds to another continuation terminal (“terminal A2”). Otherwise, the answer to the test at decision block 310 is NO, and the method 300 proceeds to block 312 where the credit card issuing bank 220 accrues the rebate amount from credit card purchases on the dual card 202. Another test is made to determine whether the rebate amount is greater than a set amount. See decision block 314. If the answer to the test at decision block 314 is NO, the method 300 loops back to block 312 where the above-described processing steps' are repeated. Otherwise, the answer to the test at decision block 314 is YES, and the credit card issuing bank 220 creates a rebate file 222 reflecting the rebate amount accrued from credit card purchases. See block 316. At block 318, the dual card support center 212 calculates the loyalty value in connection with credit transactions (hereinafter, “CC loyalty value”) from the rebate file 222 for the dual card 202. The method 300 proceeds to block 320 where the dual card support center 212 builds a file containing the calculated CC loyalty value. Next, the method 300 proceeds to the exit terminal B.

From terminal A2 (FIG. 3D), the method 400 proceeds to decision block 322 where a test is made to determine whether the credit account of the dual card 202 was used for auto-reload. If the answer to the test at decision block 322 is NO, the method 300 proceeds to terminal A to loop back to decision block 302 where the above-described processing steps are repeated. Otherwise, the answer to the test at decision block 322 is YES, and the method 300 proceeds to block 324 where the dual card support center 212 calculates the loyalty value associated with an auto-reload transaction. The dual card support center 212 builds a file reflecting the CC loyalty value associated with the auto-reload transaction. See block 326. Next, the method 300 proceeds to the exit terminal B.

From the exit terminal B (FIG. 3A), the method 400 proceeds to a set of method steps 304, defined between a continuation terminal (“terminal C”) and an exit terminal (“terminal D”). The set of method steps 304 describes the calculation of the loyalty value from stored value transactions in connection with the stored value account with the dual card 202.

From terminal C (FIG. 3E), the method 300 proceeds to decision block 328, where a test is made to determine whether a file of stored value transactions has been sent by the stored value processor 214. If the answer to the test at decision block 328 is NO, the method 300 loops back to decision block 328 where the above-described processing steps are repeated. Otherwise, the answer to the test at decision block 328 is YES, and another decision block 330 is entered by the method 300 where a test is made to determine whether the dual card reward period has cycled. If the answer to the test at decision block 330 is NO, the method 300 loops back to decision block 328 where the above-described processing steps are repeated. Otherwise, the answer to the test at decision block 330 is YES, and the method 300 proceeds to block 332 where the method 300 finds the transactions that belong to the dual card from the file of stored value transactions. The method 300 then runs a query to calculate the loyalty value based on the stored value redemptions (hereinafter SC loyalty value). See block 334. The method 300 proceeds to another continuation terminal (“terminal C1”).

From terminal C1 (FIG. 3F), the method 300 proceeds to decision block 336 where a test is made to determine whether the SC loyalty value is sufficient for merchandise rewards. If the answer is NO, the method 300 proceeds to another continuation terminal (“terminal C2”). Otherwise, the answer to the test at decision block 336 is YES, and the method 300 determines the tier of the merchandise reward to be sent to the customer 218. (The greater the tier, the greater the value of the merchandise.) See block 338. At block 340, the method 300 creates a reward file if the cardholder, who is the customer 218, has a mailing address that is valid. The method 300 then proceeds to block 342 where the method 300 sends the reward file to a fulfillment vendor. The fulfillment vendor ships the merchandise to the cardholder, which is the customer 218. See block 344. The method 300 then enters terminal C2.

From terminal C2 (FIG. 3G), the method 300 proceeds to decision block 346 where a test is made to determine whether the SC loyalty value is sufficient for a value load. If the answer is NO, the method 300 proceeds to the exit terminal D. Otherwise, the answer to the test at decision block 346 is YES, and the method 300 determines whether the cardholder qualifies for the loading level based on the SC loyalty value. See block 348. At block 350, the method 300 creates a loading file reflecting the SC loyalty value. The method 300 proceeds to block 352 where the stored value processor receives the loading file and updates the stored value account associated with the dual card 202. The method 300 (optionally) donates money to a philanthropic organization on behalf of the sponsor business, which is the customer 218. See block 354. The method 300 then proceeds to the exit terminal D.

From the exit terminal D (FIG. 3A), the method 300 proceeds to a set of method steps 306, defined between a continuation terminal (“terminal E”) and an exit terminal (“terminal F”). The set of method steps 306 describes the loading of the stored value account of the dual card 202 by the calculated loyalty value.

From terminal E (FIG. 3H), the method 300 proceeds to decision block 356 where a test is made to determine whether there is a first transaction premium file (previously created at block 308 and shown at FIG. 3B). If the answer to the test at decision block 356 is NO, the method 300 proceeds to another continuation terminal (“terminal E1”). If the answer to the test at decision block 356 is YES, the sponsor business donates money to a philanthropic organization. See block 358. At block 360, the stored value processor 214 receives the first transaction premium file. The stored value processor 214 loads funds into the stored value account associated with the dual card 202. See block 362. The method 300 then proceeds to terminal E1.

From terminal E1 (FIG. 31), the method 300 proceeds to decision block 364 where a test is made to determine whether the dual card 202 is a first edition dual card. If the answer to the test at decision block 364 is NO, the method 300 proceeds to another continuation terminal (“terminal E2”). However, if the answer to the test at decision block 364 is YES, the method 300 proceeds to another decision block 368 where another test is made to determine whether it is the first reward period for first edition dual cards. If the answer to the test at decision block 368 is YES, the method 300 instructs a fulfillment vendor to send merchandise to the cardholder, which is the customer 218. See block 370. The method 300 then enters the terminal E2. If the answer to the test at decision block 368 is NO, the method 300 proceeds to block 372 where the method instructs the stored value processor 214 to load the stored value account of the cardholder, which is the customer 218, with an amount. The method 300 then enters terminal E2.

From terminal E2 (FIG. 3J), the dual card support center 212 sends the file containing the calculated CC loyalty value to the stored value processor 214. The stored value processor receives the file, processes the file, and loads the stored value account associated with the dual card 202. See block 376. At block 378, the stored value processor 214 notifies the dual card support center 212 if an exception was generated. If an exception has been generated, the dual card support center 212 resends the file containing the calculated CC loyalty value back to the stored value processor 214 for further processing. The method 300 then enters the exit terminal F from which the method 300 terminates execution.

While the preferred embodiment of the invention has been illustrated and described, it will be appreciated that various changes can be made therein without departing from the spirit and scope of the invention.

1. A system for rewarding the loyalty of a payment cardholder, comprising:
a dual card for facilitating credit transactions associated with a credit account and further facilitating stored value transactions associated with a stored value account; and
a computer-implemented loyalty program for calculating a loyalty value based on the credit transactions of the dual card, the loyalty value being used to load the stored value account of the dual card.

2. The system of claim 1, further comprising a rebate file produced by a credit card issuing bank, the rebate file containing a rebate based on the credit transactions, the rebate file being used to aid the calculation of the loyalty value.

3. The system of claim 1, further comprising a stored value transaction file produced by a stored value processor, the stored value transaction file being used to aid the calculation of the loyalty value.

4. The system of claim 1, further comprising an amount of money donated to a philanthropic organization based on the loyalty value.

5. The system of claim 1, further comprising merchandise sent to the cardholder of the dual card based on the loyalty value.

6. A method for rewarding a cardholder of a dual card, comprising:
calculating a loyalty value from credit transactions of the dual card;
calculating the loyalty value from stored value transactions of the dual card; and
loading a stored value account of the dual card by the calculated loyalty value.

7. The method of claim 6, further comprising forming a first transaction premium file if the credit transactions include a first credit transaction.

8. The method of claim 6, further comprising accruing a rebate amount for each credit transaction.

9. The method of claim 6, further comprising accruing a rebate amount for each credit transaction that automatically occurs when a stored value account of the dual card is below a threshold.

10. The method of claim 6, further comprising donating to a philanthropic organization by a sponsor business, which sponsors the dual card and sending a piece of merchandise to the cardholder of the dual card.

11. A computer-readable medium having instructions stored thereon for performing a method for rewarding a cardholder of a dual card, comprising:
calculating a loyalty value from credit transactions of the dual card;
calculating the loyalty value from stored value transactions of the dual card; and
loading a stored value account of the dual card by the calculated loyalty value.

12. The computer-readable medium of claim 11, further comprising forming a first transaction premium file if the credit transactions include a first credit transaction.

13. The computer-readable medium of claim 11, further comprising accruing a rebate amount for each credit transaction.

14. The computer-readable medium of claim 11, further comprising accruing a rebate amount for each credit transaction that automatically occurs when a stored value account of the dual card is below a threshold.

15. The computer-readable of claim 11, further comprising donating to a philanthropic organization by a sponsor business, which sponsors the dual card and sending a piece of merchandise to the cardholder of the dual card.
